(19) United States
(12) Patent Application Publication
(10) Pub. No.: US 2019/0384934 A1
(43) Pub. Date: Dec. 19, 2019

(54) METHOD AND SYSTEM FOR PROTECTING PERSONAL INFORMATION INFRINGEMENT USING DIVISION OF AUTHENTICATION PROCESS AND BIOMETRIC AUTHENTICATION

(71) Applicant: RENOMEDIA CO., LTD., Seoul (KR)

(72) Inventor: Sang Yonn KIM, Seoul (KR)

(73) Assignee: RENOMEDIA CO., LTD., Seoul (KR)

(21) Appl. No.: 16/464,692

(22) PCT Filed: Nov. 29, 2017
(86) PCT No.: PCT/KR2017/013780

§ 371 Date: May 29, 2019

(30) Foreign Application Priority Data
Nov. 29, 2016 (KR) 10-2016-0160017
Nov. 28, 2017 (KR) 10-2017-0160162

(51) Int. Cl. G06F 21/62; G06F 21/32; H04L 9/08; H04L 9/32; H04W 12/06; H04L 29/06; G06K 7/14; G06K 7/10; G06K 19/06

(52) U.S. Cl. CPC G06F 21/6245; G06F 21/32; H04L 9/0866; H04L 9/0894; H04L 9/3231; H04L 2209/80; H04L 63/0428; G06K 7/1417; G06K 7/10722; G06K 19/06037; H04W 12/06

(57) ABSTRACT

A personal information infringement protection system, includes: a portable terminal having an application installed therein to photograph a QR code and recognize biometrics; a service server for storing the encrypted personal information, and generating an ID of a user and transmitting the ID to the portable terminal to be stored therein or informing the portable terminal of login completion when the ID received from the portable terminal is a valid ID; and a key server for generating a key value for encryption and decryption of the personal information, classifying and storing the key value by user, and providing the key value to the service server.

### TECHNICAL FIELD

The present invention relates to a method and a system for protecting infringement of personal information by combining step decomposition of an authentication process and biometric authentication.

### BACKGROUND ART

The authentication method used for a user authentication function is largely divided into a knowledge-based authentication method, an ownership-based authentication method and a biometric-based authentication method, and each of the authentication methods has a difference in convenience, cost, security and the like.

The knowledge-based authentication method is a most generalized authentication system based on an ID and a password, which has a low security level, depends on memory of a user, is vulnerable to security infringement, and should have a regeneration means when the ID or the password is lost.

In addition, the ownership-based authentication method performs authentication through a specific means that a user owns, has an average security level, and uses an OTP or a security card, and therefore although infringement by other people is difficult compared with the knowledge-based authentication method, additional cost generates, and a regeneration means should also be provided when the OTP or the security card is lost.

In addition, the biometric-based authentication method performs authentication on the basis of biometric information such as information on an iris, a fingerprint, a face or the like, and since the method uses biometric information, cost of an infrastructure for security is high, and the damage is biggest when it is invaded, although the security level is high.

Describing the knowledge-based authentication method, which is a representative authentication method, in more detail, most of Internet services are formed of a use subject (person), a use medium (PC, mobile device) and a service subject (server), and particularly in the case of a web service, all of these three components can be individually invaded, and since there is a critical problem directly connected to exposure of all personal information if any one of the components is invaded, a fundamental solution for the information infringement like this is required.

### DISCLOSURE OF INVENTION

### Technical Problem

Therefore, the present invention has been made in view of the above problems, and a personal information infringement protection system combining step decomposition of an authentication process and biometric authentication according to the present invention may separate components such as a service use subject (person), a use medium (PC, mobile device) and a service subject (server) into sections so that an individual invasion may not lead to exposure of all personal information, and make large-scale hacking attempts ineffective or meaningless even in a situation of a large-scale infringement on the service subject (server) by encrypting all the personal information of the user subject (person) individually using a key.

In addition, according to the present invention, the service use subject (person) is to eliminate any chance of theft or loss without the need of remembering or recognizing existence of an account by avoiding a situation of personal information infringement to the maximum by using a biometric information recognition function, not a knowledge-based authentication process.

In addition, according to the present invention, the use medium (PC, mobile device) is to eliminate possibility of infringement of spyware or the like installed in the use medium (PC, mobile device) by omitting a personal information input procedure itself, and store personal information in an encryption storage area provided by a platform to distribute security efforts that the service use subject bears.

In addition, according to the present invention, the service subject (server) is to extremely lower the concerns of personal information infringement by encrypting and storing personal information and separately storing a key for decryption, disable decryption of all user information by encrypting and storing the user information on the basis of a key unique to each user, and avoid invasion or infringement on all the user information caused by invasion on some users' information.

### Technical Solution

To accomplish the above objects, according to one aspect of the present invention, there is provided a personal information infringement protection system combining step decomposition of an authentication process and biometric authentication, the system including: a portable terminal having an application installed therein to photograph a QR code and recognize biometrics, for storing inputted personal information, and encrypting the personal information using a value included in the QR code and transmitting the encrypted personal information or loading a previously stored ID and transmitting the ID, if biometric recognition provided through the application is completed; a service server for storing the encrypted personal information, and generating an ID of a user and transmitting the ID to the portable terminal to be stored therein or informing the portable terminal of login completion when the ID received from the portable terminal is a valid ID; and a key server for generating a key value for encryption and decryption of the personal information, classifying and storing the key value by user, and providing the key value to the service server.

According to another embodiment of the present invention, the service server may include: a web server for providing a web screen; a web application server (WAS) for processing the personal information of the user inputted through the web server; and a database for storing the personal information of the user.

According to another embodiment of the present invention, although the service server provides a membership sign-up page, the service server outputs a QR code on behalf of a function that can directly input personal information, and the service server may provide a membership sign-up page and output a QR code on the membership sign-up page; the portable terminal may drive a service joining function by photographing the QR code through the application, input personal information through the application, and, if biometric recognition provided through the application is completed, store the personal information, encrypt the personal information using a value included in the QR code, and transmit the personal information to the service server; the service server may generate an ID of the user and transmit the ID to the key server; the key server may generate a key value and store the key value together with the user ID; the service server may receive the key value, encrypt and store the personal information, and transmit the ID to the mobile terminal; and the portable terminal may receive and store the ID and complete the service joining process.

According to another embodiment of the present invention, the service server may provide a login page, does not directly input personal information such as an ID, a password, a name or the like in a corresponding login page, and may output a QR code on the login page; the portable terminal may drive a login function by photographing the QR code through the application, and, if biometric recognition provided through the application is completed, load a previously stored ID and transmit the ID to the service server; and the service server may receive a key value corresponding to the ID from the key server and inform the portable terminal of login completion if the received ID is a valid ID.

According to another embodiment of the present invention, the key server may delete key values all together; the service server may output a QR code; the portable terminal may drive a login function by photographing the QR code through the application, and, if biometric recognition provided through the application is completed, load a previously stored ID and transmit the ID to the service server; the service server may generate a new ID and transmit the ID to the key server if the received ID is a valid ID; the key server may generate a new key value and store the key value together with the new ID; the service server may receive the new key value, encrypt and store the personal information, and transmit the new ID to the portable terminal; and the portable terminal may receive and store the new ID and complete the login process.

According to another embodiment of the present invention, there is provided a personal information infringement protection method of a personal information infringement protection system combining step decomposition of an authentication process and biometric authentication, in which the system includes a portable terminal having an application installed therein to authenticate a user, a service server for storing encrypted personal information of the user, and a key server for classifying and storing a key value for encryption and decryption of the personal information by user, and the method includes the steps of: providing a membership sign-up page and outputting a QR code on the membership sign-up page, by the service server; driving a service joining function by photographing the QR code through the application, inputting personal information through the application, and, if biometric recognition provided through the application is completed, storing the personal information, encrypting the personal information using a value included in the QR code, and transmitting the personal information to the service server, by the portable terminal; generating an ID of the user and transmitting the ID to the key server, by the service server; generating a key value and storing the key value together with the user ID, by the key server; receiving the key value, encrypting and storing the personal information, and transmitting the ID to the mobile terminal, by the service server; and receiving and storing the ID and completing the service joining process, by the portable terminal.

According to another embodiment of the present invention, the personal information infringement protection method may further include, after the step of completing the service joining process, the steps of: providing a login page and outputting a QR code on the login page, by the service server; driving a login function by photographing the QR code through the application, and, if biometric recognition provided through the application is completed, loading a previously stored ID and transmitting the ID to the service server, by the portable terminal; and receiving a key value corresponding to the ID from the key server and informing the portable terminal of login completion if the received ID is a valid ID, by the service server.

According to another embodiment of the present invention, the personal information infringement protection method may further include, after the step of completing the service joining process, the steps of: deleting key values all together, by the key server; outputting a QR code, by the service server; driving a login function by photographing the QR code through the application, and, if biometric recognition provided through the application is completed, loading a previously stored ID and transmitting the ID to the service server, by the portable terminal; generating a new ID and transmitting the ID to the key server if the received ID is a valid ID, by the service server; generating a new key value and storing the key value together with the new ID, by the key server; receiving the new key value, encrypting and storing the personal information, and transmitting the new ID to the portable terminal, by the service server; and receiving and storing the new ID and completing the login process, by the portable terminal.

According to another embodiment of the present invention, the present invention relates to a personal information infringement protection method of a personal information infringement protection system combining step decomposition of an authentication process and biometric authentication, in which the system includes a portable terminal having an application installed therein to authenticate a user, a service server for storing encrypted personal information of the user, and a key server for classifying and storing a key value for encryption and decryption of the personal information by user, and the method includes the steps of: providing a login page, and providing an application execution link or outputting a QR code on the login page, by the service server; driving a login function if the application execution link is selected or the QR code is photographed through the application, and loading a previously stored ID and transmitting the ID to the service server if biometric recognition provided through the application is completed, by the portable terminal; and informing the portable terminal of login completion if the received ID is a valid ID, by the service server.

According to another embodiment of the present invention, the personal information infringement protection method may further include, after the step of informing login completion, the steps of: transmitting a request for consent to providing personal information to the portable terminal, by the service server; transmitting an ID and the personal information encrypted using a private key, when the portable terminal receives the request for consent to providing personal information and consent to providing the personal information is selected by biometric recognition provided through the application, by the portable terminal; requesting and receiving a public key from the key server and requesting the personal information from the portable terminal when the ID that the service server has received is a valid ID, by the service server; transmitting the encrypted personal information to the service server, by the portable terminal; and decrypting the encrypted personal information using the public key received from the key server, and deleting the personal information when an expiry date of using the personal information arrives, by the service server.

According to another embodiment of the present invention, the personal information infringement protection method may further include, after the step of informing login completion, the steps of: outputting a QR code including an emergency code, by the service server; driving the login function by photographing the QR code through the application, and loading, if biometric recognition provided through the application is completed, a key-chain of a previously stored ID and transmitting the ID to the service server, by the portable terminal; transmitting, when the received ID is a valid ID, a request for regeneration of a key value and an existing key value to the portable terminal, by the service server; receiving the request for regeneration of a key value, regenerating a private key value and a public key value, decrypting the encrypted personal information using the existing key value, and encrypting the decrypted personal information using the regenerated private key value, by the portable terminal; receiving and storing the public key value and transmitting the public key value to the key server, by the service server; and deleting the existing key value, substituting the received public key value for the existing key value and storing the new key value, and informing the service server of completion of changing the key value, by the key server.

### Advantageous Effects

The personal information infringement protection system combining step decomposition of an authentication process and biometric authentication may separate components such as a service use subject (person), a use medium (PC, mobile device) and a service subject (server) into sections so that an individual invasion may not lead to exposure of all personal information, and make large-scale hacking attempts ineffective or meaningless even in a situation of a large-scale infringement on the service subject (server) by encrypting all the personal information of the user subject (person) individually using a key.

According to an embodiment of the present invention, the service use subject (person) may avoid a situation of personal information infringement to the maximum by using a biometric information recognition function, not a knowledge-based authentication process, and eliminate any chance of theft or loss without the need of remembering or recognizing existence of an account.

In addition, according to an embodiment of the present invention, the use medium (PC, mobile device) may eliminate possibility of infringement of spyware or the like installed in the use medium (PC, mobile device) by omitting a personal information input procedure itself, and store personal information in an encryption storage area provided by a platform to distribute security efforts that the service use subject bears.

In addition, according to the present invention, the service subject (server) may extremely lower the concerns of personal information infringement by encrypting and storing personal information and separately storing a key for decryption, and since the user information is encrypted and stored on the basis of a key unique to each user, it is difficult to decrypt all the user information.

### BRIEF DESCRIPTION OF THE DRAWINGS

FIG. 1 is a view illustrating a personal information infringement protection system combining step decomposition of an authentication process and biometric authentication according to an embodiment of the present invention.

FIGS. 2 to 4 are flowcharts illustrating a personal information infringement protection method combining step decomposition of an authentication process and biometric authentication according to an embodiment of the present invention.

FIGS. 5 to 7 are flowcharts illustrating a personal information infringement protection method combining step decomposition of an authentication process and biometric authentication according to another embodiment of the present invention.

### BEST MODE FOR CARRYING OUT THE INVENTION

Hereinafter, the preferred embodiments of the present invention will be described in detail with reference to the accompanying drawings. However, in describing the embodiments, when it is determined that detailed description of related known functions or constructions may obscure the gist of the present invention, the detailed description thereof will be omitted. In addition, the size of each constitutional component may be exaggerated in the drawings for explanation purpose and does not mean an actually applied size.

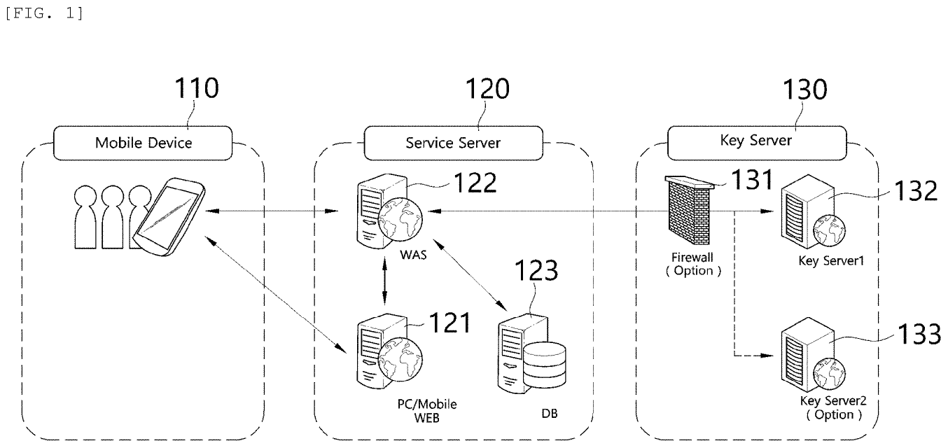

FIG. 1 is a view illustrating a personal information infringement protection system combining step decomposition of an authentication process and biometric authentication according to an embodiment of the present invention.

Hereinafter, a personal information infringement protection system combining step decomposition of an authentication process and biometric authentication according to an embodiment of the present invention will be described with reference to FIG. 1.

As shown in FIG. 1, the personal information infringement protection system combining step decomposition of an authentication process and biometric authentication according to an embodiment of the present invention is configured to include a portable terminal 110, a service server 120, and a key server 130.

An application capable of photographing a QR code and recognizing biometrics is installed in the portable terminal 110, and a user may input personal information of the user through the application. At this point, if biometric recognition is completed through a biometric information recognition function provided by the application, the portable terminal 110 may transmit the personal information to the service server 120, and the application has an authentication function based on Android and iOS platforms for login and service joining purposes.

At this point, the portable terminal 110 may store the received personal information and encrypt and transmit the personal information using a value included in the QR code when the user joins a service, and may load and transmit a previously stored ID when the user logs in the service.

When the biometric information recognition function is used as shown in an embodiment of the present invention, a situation of invading personal information can be avoided to the maximum.

The service server 120 may encrypt and store the personal information of the user inputted through the application, generate an ID of the user and transmit the ID to the portable terminal 110 to be stored therein when the user joins a service, and inform the portable terminal 110 of login completion if the ID received from the portable terminal 110 is a valid ID when the user logs in the service.

More specifically, the service server 120 may be configured to include a web server 121, a web application server (WAS) 122 and a database 123.

The web server 121 provides a web screen, and the web application server (WAS) 122 processes personal information of the user inputted through the web server, and the database 123 stores the personal information of the user.

Like this, the personal information of the user in an encrypted state is stored in the database 123, and the service server 120 should have a server software development kit (SDK) installed for communication between portable terminals 110 of users who desire to use the service and the key server 130.

The key server 130 creates a key value for encryption and decryption of the personal information, classifies and stores the key value by user, and provides the key value to the service server.

That is, the key server 130 stores, by user ID, key values needed for encryption and decryption of the personal information stored in the service server 120.

At this point, the key server 130 include a firewall 131 and may be configured of a plurality of key servers 132 and 133.

Accordingly, the personal information infringement protection system combining step decomposition of an authentication process and biometric authentication may separate components such as a service use subject (person), a use medium (PC, mobile device) and a service subject (server) into sections so that an individual invasion may not lead to exposure of all personal information, and make large-scale hacking attempts ineffective or meaningless even in a situation of a large-scale infringement on the service subject (server) by encrypting all the personal information of the user subject (person) individually using a key.

Describing in further detail, the service use subject (person) may avoid a situation of personal information infringement to the maximum by using a biometric information recognition function, not a knowledge-based authentication process, and eliminate any chance of theft or loss without the need of remembering or recognizing existence of an account.

In addition, the use medium (PC, mobile device) may eliminate possibility of infringement of spyware or the like installed in the use medium (PC, mobile device) by omitting a personal information input procedure itself, and store personal information in an encryption storage area provided by a platform to distribute security efforts that the service use subject bears.

In addition, the service subject (server) may extremely lower the concerns of personal information infringement by encrypting and storing personal information and separately storing a key for decryption, and since the user information is encrypted and stored on the basis of a key unique to each user, it is difficult to decrypt all the user information.

More specifically, for example, when a user joins a service according to an embodiment of the present invention, the service server 120 provides a membership sign-up page and outputs a QR code on the membership sign-up page, and the portable terminal 110 drives a joining function by photographing the QR code through the application and inputs personal information through the application.

In addition, if biometric recognition provided through the application is completed, the portable terminal 110 stores the personal information, encrypts the personal information using a value included in the QR code, and transmits the encrypted personal information to the service server 120.

The service server 120 generates an ID of the user and transmits the ID to the key server 130, and the key server 130 generates a key value and stores the key value together with the user ID, and the service server 120 receives the key value, encrypts and stores the personal information, and transmits the ID to the mobile terminal.

Accordingly, the portable terminal 110 may receive and store the ID and completes the joining process.

In addition, when the user logs in a service according to an embodiment of the present invention, the service server 120 provides a login page and outputs a QR code on the login page.

The portable terminal 110 drives a login function by photographing the QR code through the application, loads a previously stored ID and transmits the ID to the service server 120 if biometric recognition provided through the application is completed, and the service server 120 may receive a key value corresponding to the ID from the key server and inform the portable terminal 110 of login completion if the received ID is a valid ID.

In addition, when the service server according to an embodiment of the present invention is attacked, the key server 130 deletes key values all together.

In addition, if the service server 120 outputs a QR code, the portable terminal 110 drives a login function by photographing the QR code through the application, and then biometric recognition provided through the application is completed, the portable terminal 110 loads a previously stored ID and transmits the ID to the service server 120.

If the received ID is a valid ID, the service server 120 generates a new ID and transmits the ID to the key server 130, and the key server 130 generates a new key value and stores the key value together with the new ID, and the service server 120 receives the new key value, encrypts and stores the personal information, and transmits the new ID to the portable terminal.

Accordingly, the portable terminal 110 may receive and store the new ID and complete the login process.

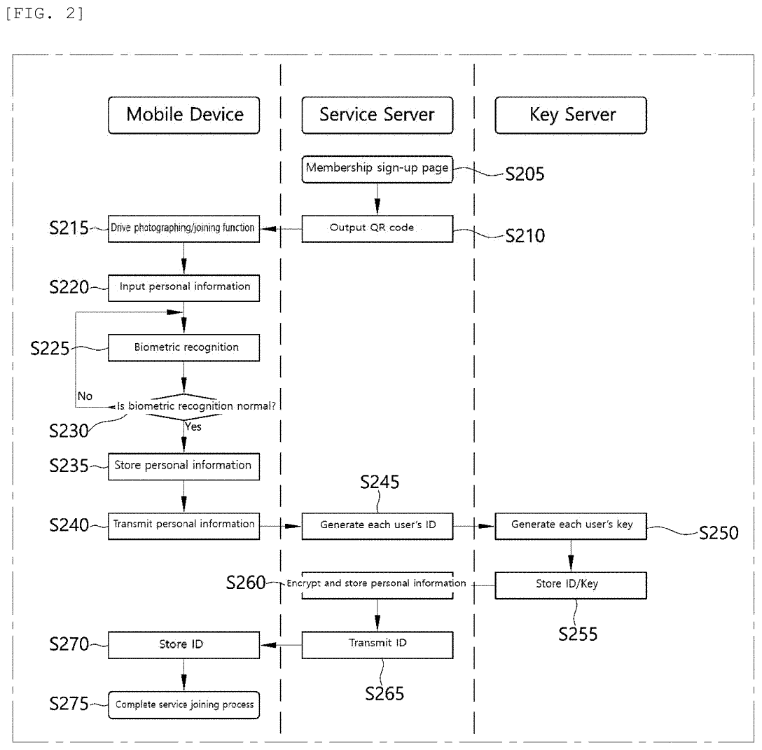

FIGS. 2 to 4 are flowcharts illustrating a personal information infringement protection method combining step decomposition of an authentication process and biometric authentication according to an embodiment of the present invention.

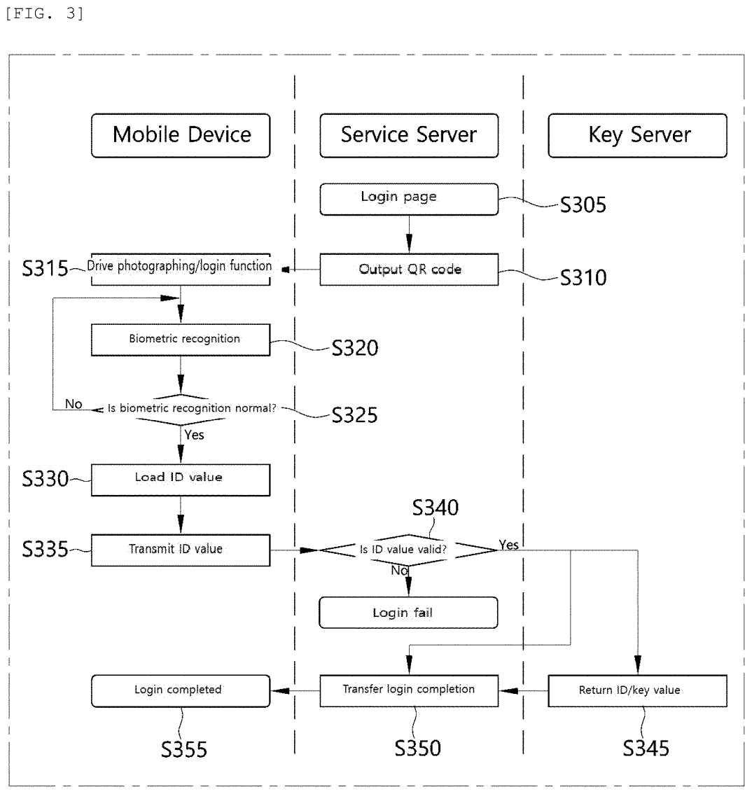

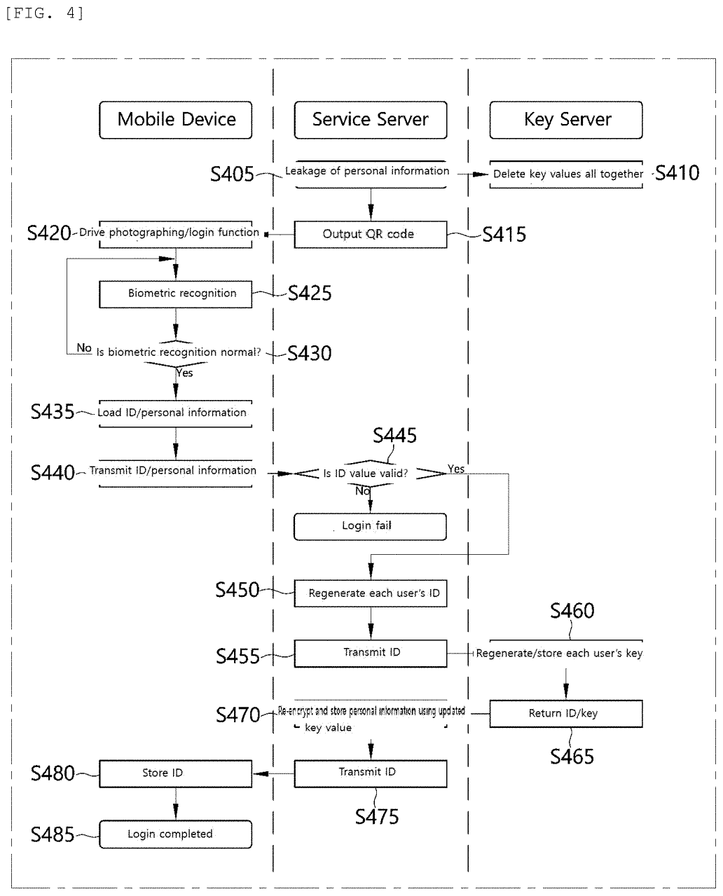

More specifically, FIG. 2 is a flowchart illustrating a control method of a personal information infringement protection system when a user joins a service according to an embodiment of the present invention, FIG. 3 is a flowchart illustrating a control method of a personal information infringement protection system when a user logs in a service according to an embodiment of the present invention, and FIG. 4 is a flowchart illustrating a control method of a personal information infringement protection system when a service server according to an embodiment of the present invention is attacked.

As shown in FIG. 2, when a user joins a service of a personal information infringement protection system according to an embodiment of the present invention, first, the service server provides a membership sign-up page (step S205) and outputs a QR code on the membership sign-up page (step S210).

That is, according to an embodiment of the present invention, since it is not allowed to directly input member information in the service server, a user may not input personal information by himself or herself when the user joins a service, and the service server may create a unique code value and output a QR code when the portable terminal drives a service joining function.

Accordingly, the portable terminal drives the service joining function by photographing the QR code through the application (step S215), and the user inputs personal information through the application (step S220).

At this point, the user may input personal information in the portable terminal or read information that has already been stored before and output the information on the screen. At this point, the previously stored information should be stored in an area such as a key-chain, which is an encryption area of the platform, or an encryption key value should be stored in the key-chain.

If biometric recognition is normally completed (step S230) through the biometric recognition function provided by the application (step S225), the portable terminal stores the personal information (step S235), encrypts the personal information using a value included in the QR code, and transmits the personal information to the service server (step S240).

At this point, biometrics such as a fingerprint, an iris, a retina, a face, a voice and the like may be used for user authentication through a biometric recognition method provided by the portable terminal, and information on the biometrics recognized at this point is not for storing in the application of the portable terminal or the service server, but it is a means for approval. Whether the biometric recognition like this is correct may be determined through the platform of the portable terminal.

Then, the service server generates a unique ID of the user and transmits the ID to the key server (step S245).

The key server generates a key value (step S250) and stores the key value together with the user ID (step S255).

Then, the service server receives the key value, encrypts and stores the personal information (step S260), and transmits the ID to the mobile terminal (step S265).

Accordingly, the portable terminal may receive and store the ID (step S270) and complete the service joining process (step S275).

As shown in FIG. 3, when a user logs in a service of a personal information infringement protection system according to an embodiment of the present invention, the service server provides a login page (step S305) and outputs a QR code on the login page (step S310).

At this point, the service server does not provide a function of directly inputting an ID and a password and may be configured to output only a QR code when a login button is clicked, and the QR code is a value for simply sharing a service flow-in path with the portable terminal.

Then, the portable terminal photographs the QR code through the application and drives a login function (step S315) and if biometric recognition is normally completed (step S325) through the biometric recognition function provided by the application (step S320), the portable terminal loads a previously stored ID (step S330) and transmits the ID to the service server (step S335).

At this point, the portable terminal may perform biometric recognition using a fingerprint, an iris, a retina, a face, a voice and the like, and if a result of the biometric recognition is abnormal or a corresponding service cannot be logged in, a guidance message such as ‘Try again’ may be outputted, and the process cannot proceed until the result of the biometrics recognition is confirmed normal.

Then, the service server determines whether the received ID is a valid ID (step S340), and if the received ID is a valid ID (step S345), the service server may receive a key value corresponding to the ID from the key server, transfer whether the login is completed (step S350), and inform the portable terminal of login completion.

At this point, the service server may also be configured to determine whether the received ID is a valid ID (step S340), transfer whether the login is completed if the received ID is a valid ID (step S350), and directly inform the portable terminal of login completion (step S355).

Meanwhile, when the received ID is not a valid ID, the login is processed as a failure.

If the personal information is leaked (step S405) when the service server of the personal information infringement protection system according to an embodiment of the present invention is attacked as shown in FIG. 4, the key server deletes the key values all together (step S410), and the service server outputs a QR code (step S415).

Since the personal information stored in the service server is in an encrypted state, a decryption key is necessarily needed. Accordingly, the key values of the users are deleted to prevent further damage.

Then, the portable terminal drives a login function by photographing the QR code through the application (step S420), and if biometric recognition provided through the application is completed (steps S425 and S430), the portable terminal loads a previously stored ID and transmit the ID to the service server 120 (step S440).

At this point, the QR code is a value including an emergency code, in addition to the purpose of sharing a service flow-in path with the portable terminal in a general login situation.

If the received ID is a valid ID (step S445) and the service server regenerates a new ID (step S450) and transmits the new ID to the key server (S455), and the key server may generate a new key value and stores the key value together with the new ID (step S460) and transmit the key value and the new ID (step S465).

When the previous key value is not deleted when the key value is updated with the new value, the previous key value is deleted, and the key value is updated and stored using the newly generated key value.

Accordingly, the service server receives the new key value, encrypts and stores the personal information (step S470), and transmits the new ID (step S475).

Accordingly, the portable terminal receives and stores the new ID (step S480) and completes the login process (step S485).

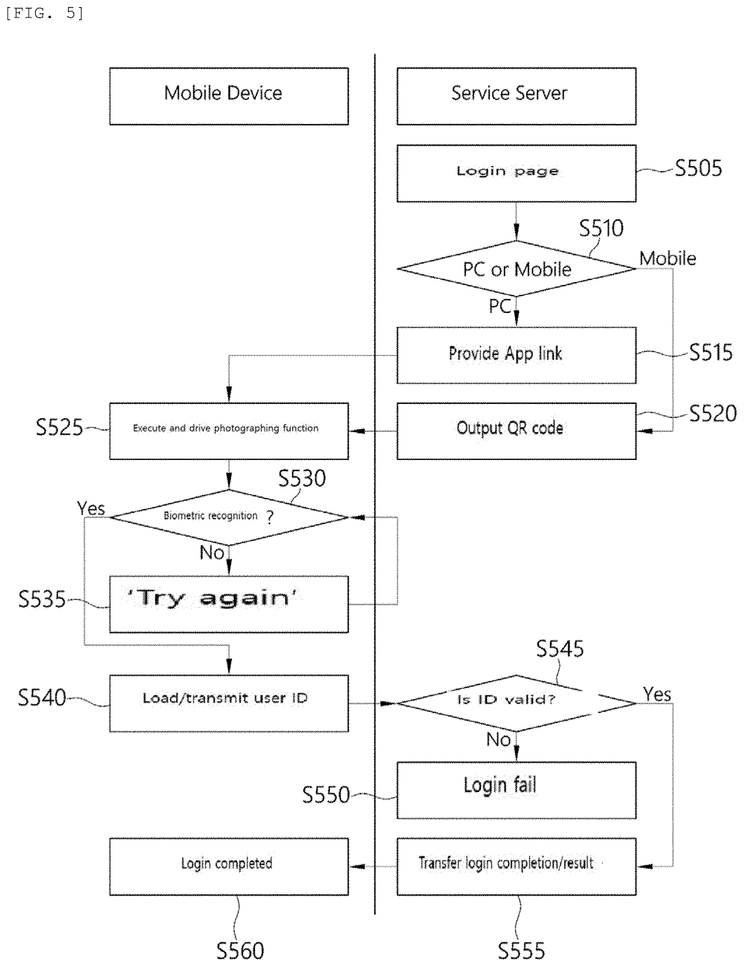

FIGS. 5 to 7 are flowcharts illustrating a personal information infringement protection method combining step decomposition of an authentication process and biometric authentication according to another embodiment of the present invention.

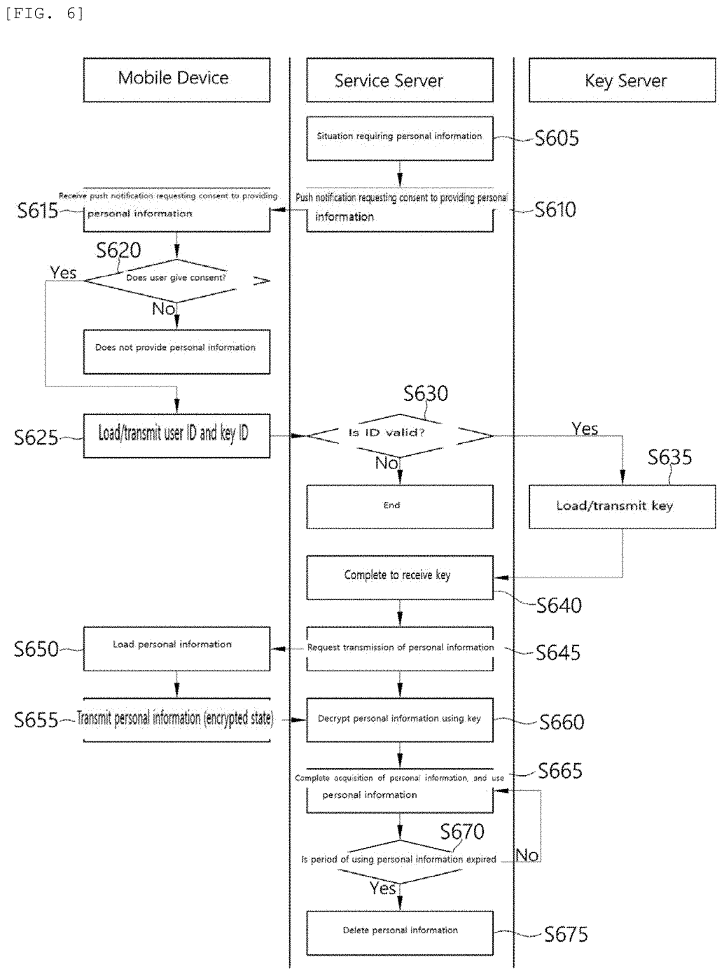

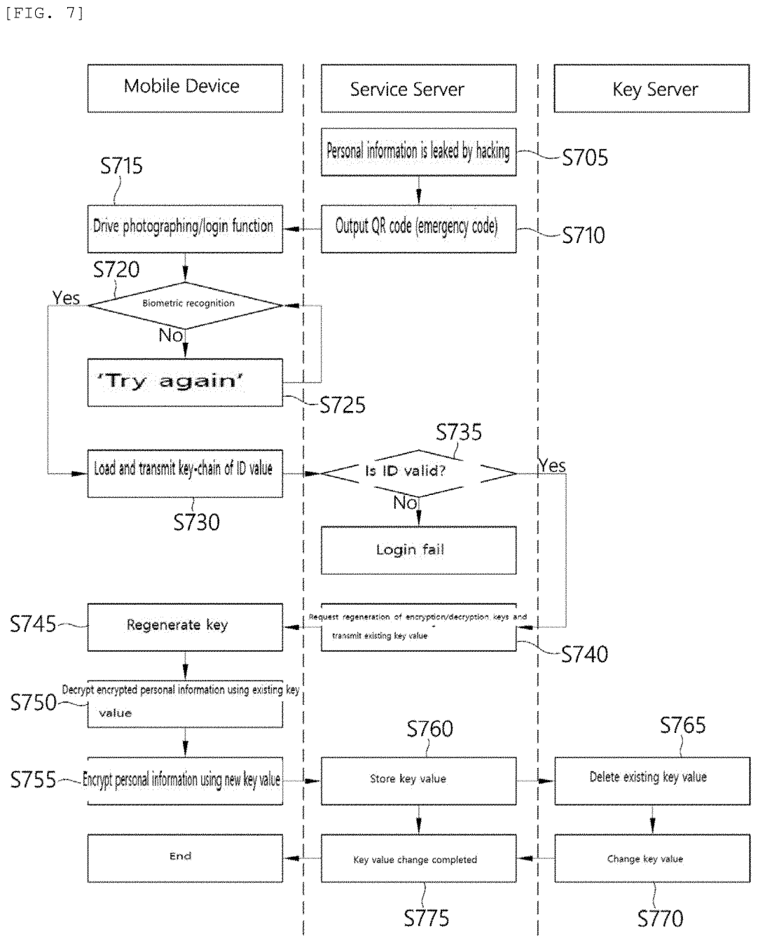

More specifically, FIG. 5 is a flowchart illustrating a login method of a service according to another embodiment of the present invention, FIG. 6 is a flowchart illustrating a method of requesting consent to providing membership information according to another embodiment of the present invention, and FIG. 7 is a flowchart illustrating a personal information infringement protection method when personal information is leaked according to another embodiment of the present invention.

As shown in FIG. 5, when a user logs in a service according to another embodiment of the present invention, the service server provides a login page (step S505), determines whether a terminal receiving the login page is a computer terminal (PC) or a portable terminal (mobile terminal) (step S510), and provides an application execution link on the login page (step S515) or outputs a QR code on the login page (step S520).

At this point, the service server does not provide a function of directly inputting an ID and a password, and when the terminal is a portable terminal, the service server creates a unique code value and puts the corresponding value into the application execution link if the user selects a login button, and the login function installed in the portable terminal of the user is executed. In addition, when the terminal is a computer terminal, the service server creates and provides a QR code using a unique code value if the user selects the login button and may execute the login function by photographing the QR code through the portable terminal.

Then, if biometric recognition is normally completed through the biometric recognition function provided by the application (step S530) while the application execution link is selected and the login function is driven through the application or the login function is driven by photographing the QR code through the application (step S525), the portable terminal loads a previously stored ID and transmits the ID to the service server (step S540).

At this point, the portable terminal may perform biometric recognition using a fingerprint, an iris, a retina, a face, a voice and the like, and if a result of the biometric recognition is abnormal or a corresponding service cannot be logged in, a guidance message such as ‘Try again’ may be outputted (step S540), and the process cannot proceed until the result of the biometrics recognition is confirmed normal.

The biometric recognition using biometric information like this is not intended to store the biometric information in the portable terminal or the service server or to verify the biometric information by comparing after storing the biometric information, but it is a means for verifying primary validity by determining the owner of the portable terminal. The biometric recognition like this is provided through the portable terminal.

Then, the service server determines whether the received ID is a valid ID (step S545) and informs the portable terminal of login completion if the received ID is a valid ID (step S555), and login is completed on the portable terminal side (step S560).

Meanwhile, when the received ID is not a valid ID, the login is processed as a failure (step S550).

In the case of requesting consent to providing member information as shown in FIG. 6, if personal information of a user is needed for the business purpose of an online service provider (step S605), the service server transmits the request for consent to providing personal information to the user through a push notification service (step S610).

Accordingly, if the portable terminal receives the push notification which requests personal information (step S615) and selects ‘consent to providing personal information’ (step S620), a user ID stored in the portable terminal and personal information encrypted using a private key are transmitted to the service server (step S625).

When the received ID is valid, the service server requests and receives a public key from the key server (steps S635 and S640) and requests the portable terminal to transmit personal information (step S645).

If the request is received, the portable terminal loads the personal information (step S650) and transmits encrypted personal information to the service server (S655).

The service server receives the personal information and may decrypt the encrypted personal information using the public key received from the key server (step S660) and acquire and use the personal information (step S665).

Then, if the expiry date of using the personal information arrives, the service server deletes the personal information.

FIG. 7 is a flowchart illustrating a personal information infringement protection method when personal information is leaked according to another embodiment of the present invention.

When a situation of leaking personal information occurs in a large scale, since the basic personal information is in an encrypted state, the service server necessarily needs a public key for decryption. Although there is no possibility of decryption in this case as far as the separately operated key server is not hacked at the same time, according to an embodiment of the present invention, there is provided a process for updating existing encryption/decryption key values (private key/public key) just in case.

When the personal information is leaked by hacking (step S705), the service server output a QR code including an emergency code (step S710).

The portable terminal drives the login function by photographing the QR code through the application (step S715), and if biometric recognition provided through the application is completed (step S720), the portable terminal loads a key-chain of a previously stored ID and transmit the ID to the service server (step S730).

At this point, the portable terminal may perform biometric recognition using a fingerprint, an iris, a retina, a face, a voice and the like, and if a result of the biometric recognition is abnormal or a corresponding service cannot be logged in, a guidance message such as ‘Try again’ may be outputted (step S725), and the process cannot proceed until the result of the biometrics recognition is confirmed normal.

When the received ID is a valid ID (step S735), the service server transmits a request for regeneration of a key value and the existing key value to the portable terminal (step S740).

Accordingly, the portable terminal receives the request for regeneration of a key value and regenerates a private key value and a public key value (step S745), decrypts the encrypted personal information using the existing key value (step S750), and encrypts the decrypted personal information using the regenerated private key value (step S755).

The service server receives and stores the public key value (step S760) and transmits the public key value to the key server.

The key server deletes the existing key value (step S765), substitutes the received public key value for the existing key value and stores the new key value (step S770), and informs the service server of completion of changing the key value, and the service server completes the process of changing the key value (step S775).

Specific embodiments have been described in the detailed description of the present invention as described above. However, various modifications can be made without departing from the scope of the present invention. The spirit of the present invention should not be defined to be limited to the embodiment of the present invention described above and should be defined by the claims and equivalents thereof.

1. A personal information infringement protection system combining step decomposition of an authentication process and biometric authentication, the system comprising:
a portable terminal having an application installed therein to photograph a QR code and recognize biometrics, for storing inputted personal information, and encrypting the personal information using a value included in the QR code and transmitting the encrypted personal information or loading a previously stored ID and transmitting the ID, if biometric recognition provided through the application is completed;
a service server for storing the encrypted personal information, and generating an ID of a user and transmitting the ID to the portable terminal to be stored therein or informing the portable terminal of login completion when the ID received from the portable terminal is a valid ID; and
a key server for generating a key value for encryption and decryption of the personal information, classifying and storing the key value by user, and providing the key value to the service server.

2. The system according to claim 1, wherein the service server includes:
a web server for providing a web screen;
a web application server (WAS) for processing the personal information of the user inputted through the web server; and
a database for storing the personal information of the user.

3. The system according to claim 1, wherein the service server provides a and outputs a QR code on the membership sign-up page; the portable terminal drives a service joining function by photographing the QR code through the application, inputs personal information through the application, and, if biometric recognition provided through the application is completed, stores the personal information, encrypts the personal information using a value included in the QR code, and transmits the personal information to the service server; the service server generates an ID of the user and transmits the ID to the key server; the key server generates a key value and stores the key value together with the user ID; the service server receives the key value, encrypts and stores the personal information, and transmits the ID to the mobile terminal; and the portable terminal receives and stores the ID and completes the service joining process.

4. The system according to claim 1, wherein the service server provides a login page and outputs a QR code on the login page; the portable terminal drives a login function by photographing the QR code through the application, and, if biometric recognition provided through the application is completed, loads a previously stored ID and transmits the ID to the service server; and the service server receives a key value corresponding to the ID from the key server and informs the portable terminal of login completion if the received ID is a valid ID.

5. The system according to claim 1, wherein the key server deletes key values all together; the service server outputs a QR code; the portable terminal drives a login function by photographing the QR code through the application, and, if biometric recognition provided through the application is completed, loads a previously stored ID and transmits the ID to the service server; the service server generates a new ID and transmits the ID to the key server if the received ID is a valid ID; the key server generates a new key value and stores the key value together with the new ID; the service server receives the new key value, encrypts and stores the personal information, and transmits the new ID to the portable terminal; and the portable terminal receives and stores the new ID and completes the login process.

6. A personal information infringement protection method of a personal information infringement protection system combining step decomposition of an authentication process and biometric authentication, the system comprising a portable terminal having an application installed therein to authenticate a user, a service server for storing encrypted personal information of the user, and a key server for classifying and storing a key value for encryption and decryption of the personal information by user, and the method comprising the steps of:
providing a membership sign-up page and outputting a QR code on the membership sign-up page, by the service server;
driving a service joining function by photographing the QR code through the application, inputting personal information through the application, and, if biometric recognition provided through the application is completed, storing the personal information, encrypting the personal information using a value included in the QR code, and transmitting the personal information to the service server, by the portable terminal;
generating an ID of the user and transmitting the ID to the key server, by the service server;
generating a key value and storing the key value together with the user ID, by the key server;
receiving the key value, encrypting and storing the personal information, and transmitting the ID to the mobile terminal, by the service server; and
receiving and storing the ID and completing the service joining process, by the portable terminal.

7. The method according to claim 6, further comprising, after the step of completing the service joining process, the steps of:
providing a login page and outputting a QR code on the login page, by the service server;
driving a login function by photographing the QR code through the application, and, if biometric recognition provided through the application is completed, loading a previously stored ID and transmitting the ID to the service server, by the portable terminal; and
receiving a key value corresponding to the ID from the key server and informing the portable terminal of login completion if the received ID is a valid ID, by the service server.

8. The method according to claim 6, further comprising, after the step of completing the service joining process, the steps of:
deleting key values all together, by the key server;
outputting a QR code, by the service server;
driving a login function by photographing the QR code through the application, and, if biometric recognition provided through the application is completed, loading a previously stored ID and transmitting the ID to the service server, by the portable terminal;
generating a new ID and transmitting the ID to the key server if the received ID is a valid ID, by the service server;
generating a new key value and storing the key value together with the new ID, by the key server;
receiving the new key value, encrypting and storing the personal information, and transmitting the new ID to the portable terminal, by the service server; and
receiving and storing the new ID and completing the login process, by the portable terminal.

9. A personal information infringement protection method of a personal information infringement protection system combining step decomposition of an authentication process and biometric authentication, the system comprising a portable terminal having an application installed therein to authenticate a user, a service server for storing encrypted personal information of the user, and a key server for classifying and storing a key value for encryption and decryption of the personal information by user, and the method comprising the steps of:
providing a login page, and providing an application execution link or outputting a QR code on the login page, by the service server;
driving a login function if the application execution link is selected or the QR code is photographed through the application, and loading a previously stored ID and transmitting the ID to the service server if biometric recognition provided through the application is completed, by the portable terminal; and
informing the portable terminal of login completion if the received ID is a valid ID, by the service server.

10. The method according to claim 9, further comprising, after the step of informing login completion, the steps of:
transmitting a request for consent to providing personal information to the portable terminal, by the service server;
transmitting an ID and the personal information encrypted using a private key, when the portable terminal receives the request for consent to providing personal information and consent to providing the personal information is selected by biometric recognition provided through the application, by the portable terminal;
requesting and receiving a public key from the key server and requesting the personal information from the portable terminal when the ID that the service server has received is a valid ID, by the service server;
transmitting the encrypted personal information to the service server, by the portable terminal; and
decrypting the encrypted personal information using the public key received from the key server, and deleting the personal information when an expiry date of using the personal information arrives, by the service server.

11. The method according to claim 9, further comprising, after the step of informing login completion, the steps of:
outputting a QR code including an emergency code, by the service server;
driving the login function by photographing the QR code through the application, and loading, if biometric recognition provided through the application is completed, a key-chain of a previously stored ID and transmitting the ID to the service server, by the portable terminal;
transmitting, when the received ID is a valid ID, a request for regeneration of a key value and an existing key value to the portable terminal, by the service server;
receiving the request for regeneration of a key value, regenerating a private key value and a public key value, decrypting the encrypted personal information using the existing key value, and encrypting the decrypted personal information using the regenerated private key value, by the portable terminal;
receiving and storing the public key value and transmitting the public key value to the key server, by the service server; and
deleting the existing key value, substituting the received public key value for the existing key value and storing the new key value, and informing the service server of completion of changing the key value, by the key server.
